(19) United States
(12) Patent Application Publication
(10) Pub. No.: US 2008/0250326 A1
(43) Pub. Date: Oct. 9, 2008

(54) User-defined visual indicators on dynamic charts

(75) Inventor: Thanhy Mather, Saratoga, CA (US)

Correspondence Address: YAHOO C/O MOFO PALO ALTO, 755 PAGE MILL ROAD, PALO ALTO, CA, 94304, US

(73) Assignee: Yahoo! Inc., Sunnyvale, CA (US)

(21) Appl. No.: 11/732,863

(22) Filed: Apr. 4, 2007

(51) Int. Cl. G06F 3/00; G06F 17/00

(52) U.S. Cl. 715/744

(57) ABSTRACT

In accordance with embodiments of the present invention, a method for providing a user-defined visual indicator on a dynamically generated graphical representation of real-time data is provided. The method includes receiving at least one user-defined condition related to the real-time data. The user-defined condition includes at least one external data condition. The method further includes receiving at least one external data related to the at least one external data condition, and providing at least one visual indicator for display along with a dynamically generated graphical representation of the real-time data in response to satisfaction of the at least one user-defined condition. In some embodiments, the at least one external data condition relates to a sentiment measure. Furthermore, in some embodiments, the sentiment measure is determined from a plurality of users.

### BACKGROUND OF THE INVENTION

Dynamically generated charts provide a visual representation of real-time data quickly to a client in a client/server architecture. Utilizing dynamically generated charts for displaying financial data, such as data related to stocks, allows for an accurate visualization of data that is constantly changing. Providing symbols, or indicators, indicating potentially relevant information related to the data series displayed on a dynamic chart may be useful in analyzing trends and explaining data fluctuations.

Previously, finance-related dynamic charts would provide indicators to signal splits, dividends, or news stories associated with a particular data series displayed in a dynamic chart. In FIG. 1A, a finance dynamic chart 100 is illustrated including a stock price plot 104. Symbols 102 indicating splits are displayed along the corresponding price and time of the stock price plot 104.

FIG. 1B illustrates another example of a financial dynamic chart 120 showing a stock price plot 122. Displayed on dynamic chart 120, are news article indicators that may be relevant to the specific stock price plot 120, which indicate the time the news article was released. For example, news indicator 124 is associated with news article 126. The news article indicators may indicate to a user that the news article may have had some impact on the stock price. However, a news article irrelevant to a stock trader or buyer may falsely indicate a possible source for a stock price fluctuation.

Although technical analysis indicators provide useful information to a user, the technical indicators provide only limited insight into the data series displayed on the dynamic chart. These types of predefined technical indicators are options provided to a user. The user may then choose which indicators they would like to be displayed on the chart. However, the indicators are not defined by the user, and the user may not customize the indicator according to specific conditions the user may be interested in. Moreover, purely technical indicators do not show the impact of the indicated event on a group of people or an individual, or the social sentiment at the time that may affect the real-time data series on a dynamic chart.

Therefore, the ability for a user to define visual indicators with content from more than one source on a dynamically generated chart is desired.

### BRIEF SUMMARY OF THE INVENTION

In accordance with embodiments of the present invention, a method for providing a user-defined visual indicator on a dynamically generated graphical representation of real-time data is provided. The method includes receiving at least one user-defined condition related to the real-time data. The user-defined condition includes at least one external data condition. The method further includes receiving at least one external data related to the at least one external data condition, and providing at least one visual indicator for display along with a dynamically generated graphical representation of the real-time data in response to satisfaction of the at least one user-defined condition. In some embodiments, the at least one external data condition relates to a sentiment measure. Furthermore, in some embodiments, the sentiment measure is associated with opinions of a community of users.

In accordance with other embodiments of the present invention, an apparatus for providing a user-defined visual indicator on a dynamically generated graphical representation of real-time data is provided. According to embodiments of the invention, the apparatus comprises: means for receiving at least one user-defined condition related to the real-time data; means for receiving at least one external data related to the at least one external data condition; and display means for providing at least one visual indicator for display along with the a dynamically generated graphical representation of the real-time data in response to satisfaction of the at least one user-defined condition.

Other features and aspects of the invention will become apparent from the following detailed description, taken in conjunction with the accompanying drawings which illustrate, by way of example, the features in accordance with embodiments of the invention. The summary is not intended to limit the scope of the invention, which is defined solely by the claims attached hereto.

### BRIEF DESCRIPTION OF THE DRAWINGS

FIG. 1A illustrates a dynamic flash-based stock price versus time chart including split indicators;

FIG. 1B illustrates a dynamic flash-based stock price versus time chart including news indicators;

FIG. 2 is a flowchart illustrating an embodiment of a method of generating a dynamic chart with user-defined alerts;

FIG. 3 is a block diagram illustrating an embodiment of a system for generating a dynamic chart with user-defined alerts;

FIG. 4 illustrates an embodiment of a dynamic chart with user-defined alerts;

FIG. 5 illustrates an embodiment of a dynamic chart with user-defined alerts including community sentiment related to the alert;

FIG. 6 illustrates an embodiment of financial analyst sentiment data;

FIG. 7 illustrates an embodiment of community sentiment data;

FIG. 8 illustrates another embodiment of community sentiment data;

FIG. 9 illustrates an embodiment of annotations of a user-defined alert on a dynamic chart; and

FIG. 10 is a block diagram of a embodiment of a computer system.

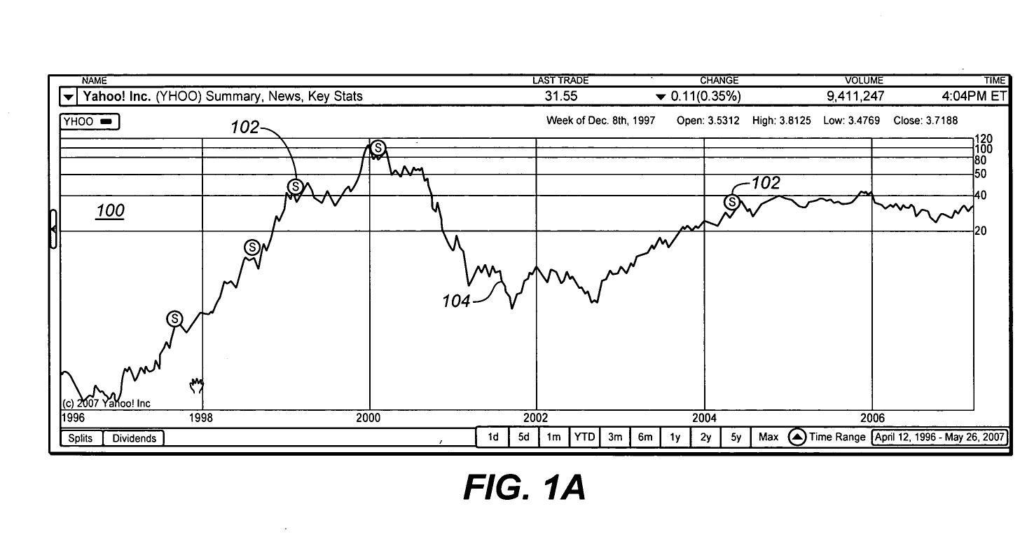

The present invention and its various embodiments are better understood upon consideration of the detailed description below in conjunction with the accompanying drawings and claims.

In the following description, reference is made to the accompanying drawings which form a part thereof, and which illustrate several embodiments of the present invention. It is understood that other embodiments may be utilized and structural and operational changes may be made without departing from the scope of the present invention. The use of the same reference symbols in different drawings indicates similar or identical items.

### DETAILED DESCRIPTION OF THE INVENTION

The following description is presented to enable any person of ordinary skill in the art to make and use the invention. Descriptions of specific materials, techniques, and applications are provided only as examples. Various modifications to the examples described herein will be readily apparent to those of ordinary skill in the art, and the general principles defined herein may be applied to other examples and applications without departing from the spirit and scope of the invention. Thus, the present invention is not intended to be limited to the examples described and shown, but is to be accorded the scope consistent with the appended claims.

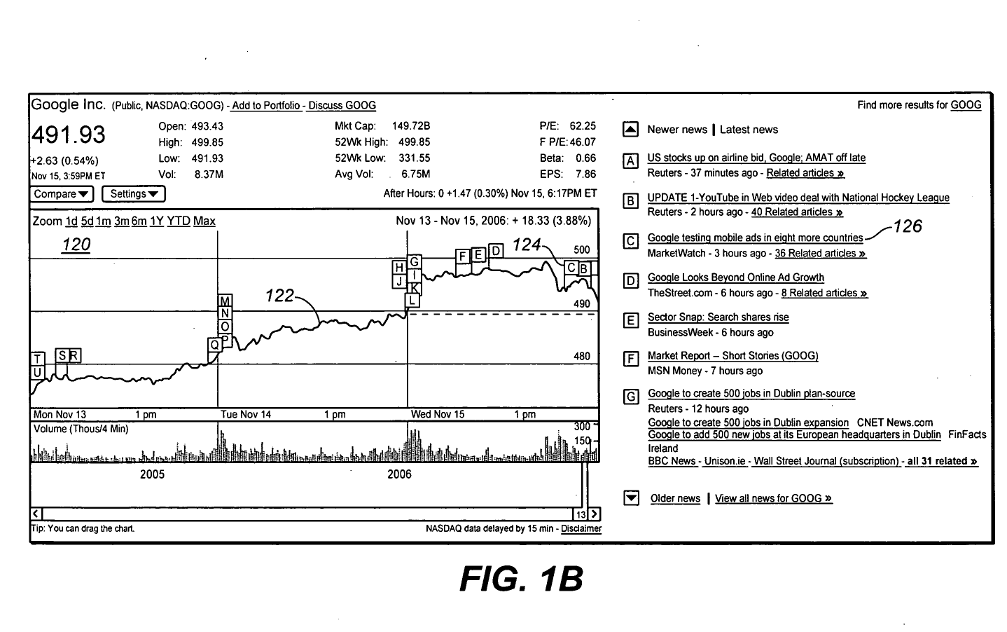

FIG. 2 is a flowchart illustrating a method 200 for providing a visual indicator based on a user-defined condition. According to embodiments of the present invention, the user-defined visual indicator is displayed on a dynamically generated graphical representation of real-time data. In 202, a user defines the condition for providing a visual indicator. Similar to the traditional database query language statements, user-defined conditions may be constructed manually or copied from a template library of predefined conditions. The user-defined condition is evaluated in, for example, a time series detection engine in 204. A database may also be used to evaluate the user-defined condition. The evaluation in the time series detection engine may receive external data that may be required to be evaluated by the user-defined condition. The time series detection engine determines an alert data series, which comprises the decisions at 206 by the time series detection engine concerning the satisfaction of the user-defined condition. If the user-defined condition is satisfied, the alert data will be combined with the real-time data series in 208 (“mash-up data”), and a visual indicator will be provided on the dynamic chart. A mash-up is known in the art as a combination of content from more than one source to provide an integrated application. The mash-up data is used to dynamically generate a dynamic chart in 210 to display the real-time data series and the visual indicators, which indicate the satisfaction of the user-defined condition related to the real-time data.

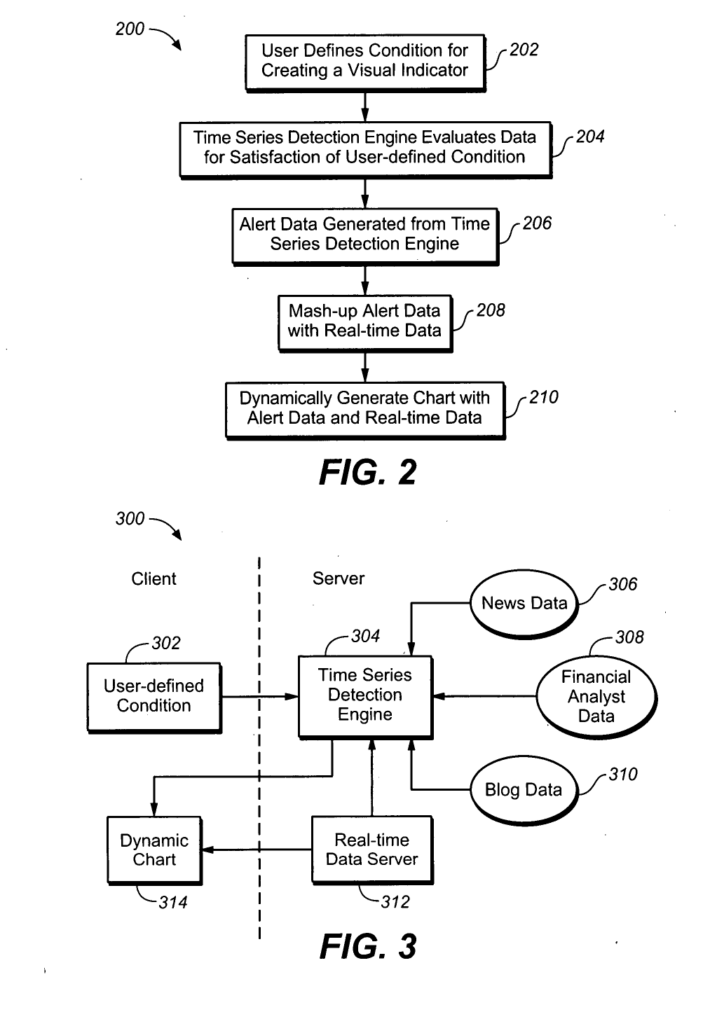

FIG. 3 illustrates a block diagram of the system 300 according to embodiments of the present invention. A user-defined condition 302 for a visual indicator originates from a client-side user. A time series detection engine 304 receives the user-defined condition 302, and any external data needed for the user-defined condition. The external data may include news 306, financial analyst data 308, and web log (blog) data 310, for example. The time series detection engine 304 also receives the real-time data for evaluation of the user-defined condition 302. The time series detection engine 304 evaluates the user-defined condition and determines whether the user-defined condition is satisfied in alert data. A database may be used to evaluate the user-defined condition 302. The client-side display 314 receives the alert data and associated real-time data from the real-time data server 312 and dynamically generates a graphical representation of the real-time data and user-defined indicators.

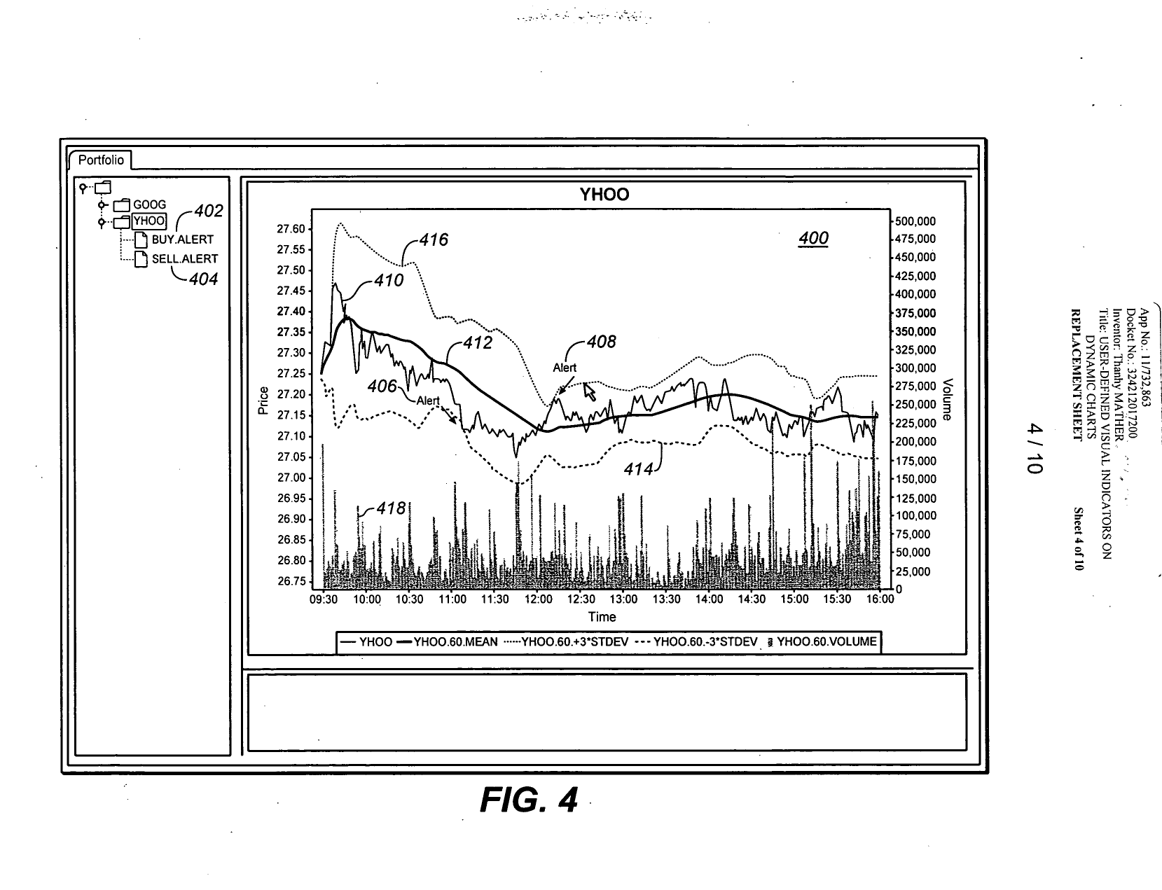

Two examples of user-defined visual indicators displayed on a dynamically generated graphical representation are illustrated in FIG. 4. For stock prices, a “buy alert” 402 and a “sell alert” 404 are defined by a user. The user-defined conditions are defined in Boolean-type expressions as a set of conditions. In this example, the buy alert 402 is displayed on the dynamic chart 400 alongside the stock price data 410 when the price is three standard deviations below the average price value. An example of the Boolean expression used to define the buy alert 402 is:
Select YHOO.60.VAL FROM WHERE YHOO.60.VAL<YHOO.60.MEAN−3*YHOO.60.STDEV

Similarly, the sell alert 404 is displayed on the dynamic chart 400 alongside the stock price data 410 when the price is three standard deviations above the average price value. An example of the Boolean expression used to define the sell alert 404 is:
Select YHOO.60.VAL FROM WHERE YHOO.60.VAL>YHOO.60.MEAN+3*YHOO.60.STDEV

An alert visual indicator is provided on the dynamic chart 400 alongside the stock price data 410 when the user-defined conditions for the buy alert and/or the sell alert are satisfied. When the buy alert 402 conditions are satisfied, a corresponding indicator 406 is displayed on the dynamic chart 400. Likewise, when the sell alert 404 conditions are satisfied, a corresponding indicator 407 is displayed.

In the present example, statistical data, such as moving average and standard deviations must be calculated to evaluate the user-defined conditions of the buy alert 402 and sell alert 404. These statistical analyses are visually displayed on the dynamic chart 400: the moving average plot 412, three standard deviations below the average plot 414, and three standard deviations above the average plot 416. Moreover, the volume 418 may also be displayed on the same dynamic chart 400.

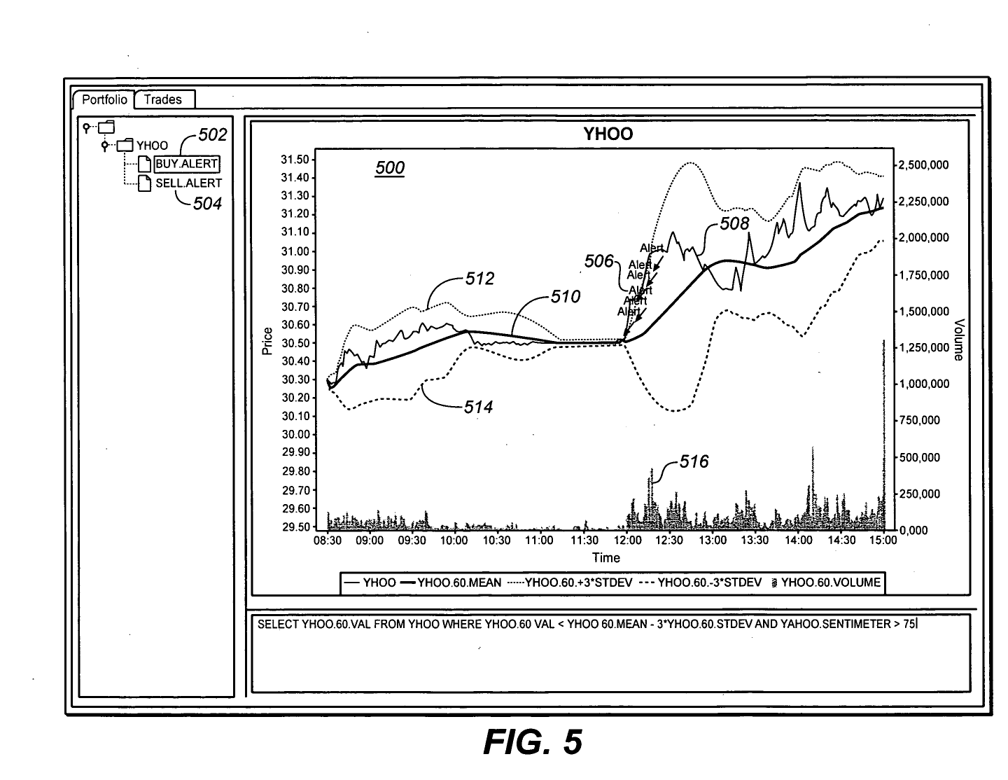

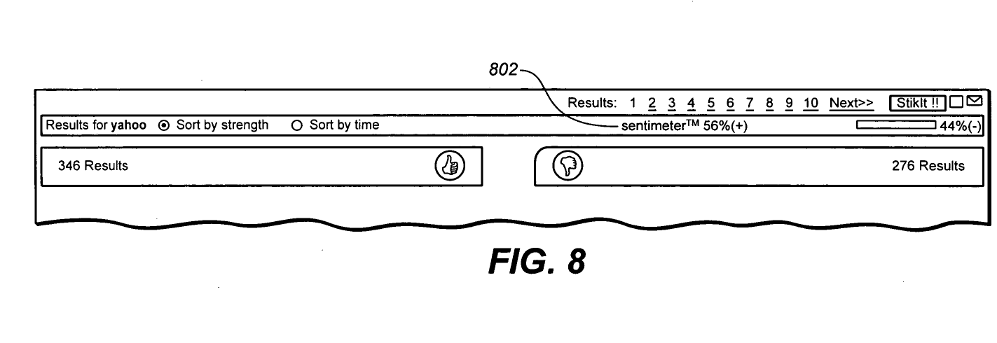

Another example is illustrated in FIG. 5, in which the user-defined condition for providing a visual indicator on a dynamic chart includes external data, such as a sentiment measure. A sentiment measure may be a value related to an opinion, rating, or attitude, for example. A sentiment measure can be determined by a community of users or an individual. Blogs, available financial analyst ratings, or message boards, may be external data sources for determining a sentiment measure. In the example of FIG. 5, a visual indicator is provided on the dynamic chart 500 when the buy alert 502 or the sell alert 504, according to user-defined conditions, are satisfied. A visual indicator alert 506, according to satisfaction of the conditions of the sell alert, is displayed on the dynamic chart 500 when the price is greater than three standard deviations above the mean price, and the Yahoo! “sentimeter” rating is greater than 75. In this example, the rating comes from a “sentimeter” source that is an external data source that is illustrated in FIG. 8, for example. The Boolean expression for the sell alert 504 may be formatted as follows:
Select YHOO.60.VAL FROM WHERE YHOO.60.VAL>YHOO.60.MEAN+3*YHOO.60.STDEV AND YAHOO.SENTIMETER.RATING>75

The sentiment measure in this example, the sentimeter rating, may be determined by a variety of methods. For example, the frequency of related news stories that reference Yahoo! at the current time may relate the affect of a particular event on the stock market. A high frequency of related news stories may mean that the news event has a significant impact on the stock market, while a low frequency may mean that this news event may have an insignificant impact on the stock market. Alternatively, the sentimeter rating may be a value determined by positive or negative opinions expressed in blogs of a community of users. In general, a sentiment measure may be a quantitative representation of opinions, attitude, or bias for any topic such as an instrument, asset, product, or company.

Similar to the example in FIG. 4, statistical data, such as moving average and standard deviations must be calculated to evaluate the user-defined conditions of the sell alert 504. The statistical data may also be displayed on the dynamic chart 500. The moving average plot 510, three standard deviations above the average plot 512, and three standard deviations below the average plot 514, are displayed on the dynamic chart 500. Moreover, the volume 516 is also displayed on the dynamic chart 500.

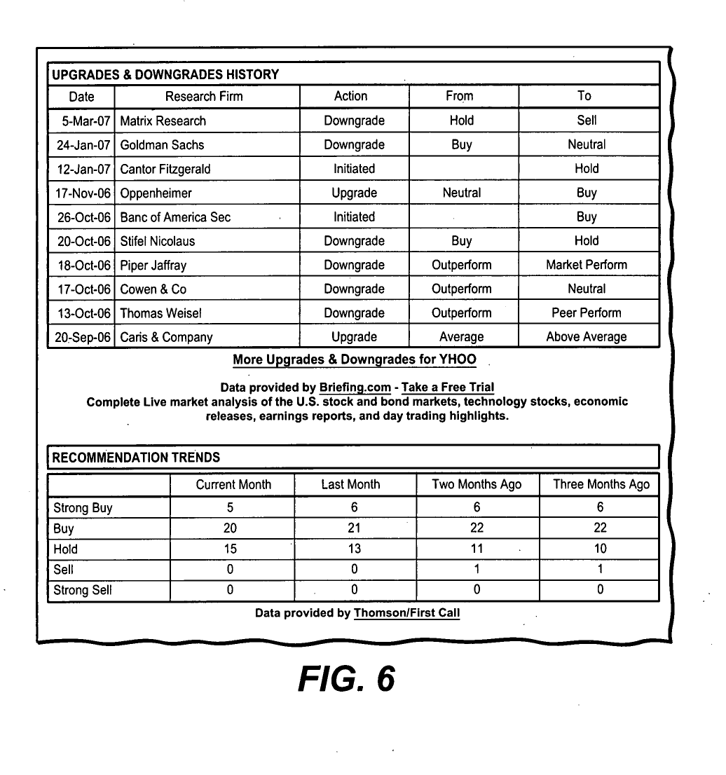

Sentiment measures may be determined from a variety of external sources. FIG. 6 illustrates an example of an external data source related to various financial research analyst firms recommendations regarding Yahoo! stock. According to embodiments of the present invention, a user may define a condition for a visual indicator that is related to a particular firm and their recommended action. The data from the external source shown in FIG. 6 may be evaluated to determine if the user-defined condition is satisfied.

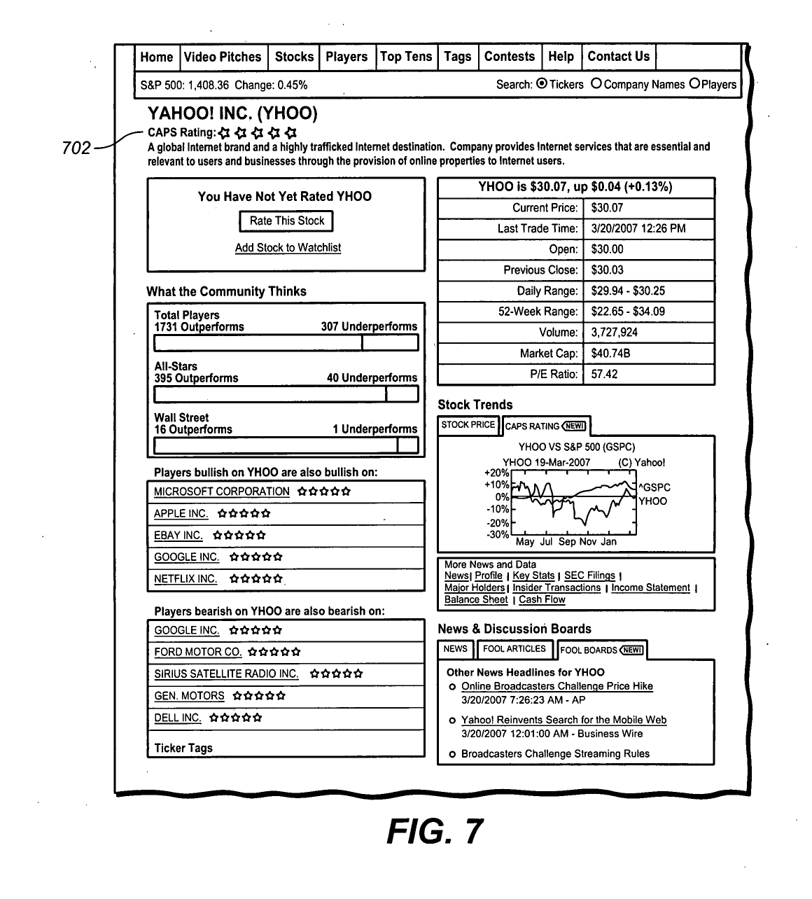

Another example of an external data source that maybe used to determine a sentiment measure is illustrated in FIG. 7. In this example, a community of users determines a rating 702 on Yahoo! stock.

FIG. 8 illustrates a “sentimeter” rating 802 based on sentiment based in blogs of the users. In this example, the sentimeter rating 802 shows 56% have a positive sentiment related to Yahoo!.

By enriching alerts with user comments and opinions, additional insight is gained for a particular stock trends and anomalies that may not be otherwise be captured by pure technical analysis. This may more accurately detect trade opportunities or limit risks for an existing trade position.

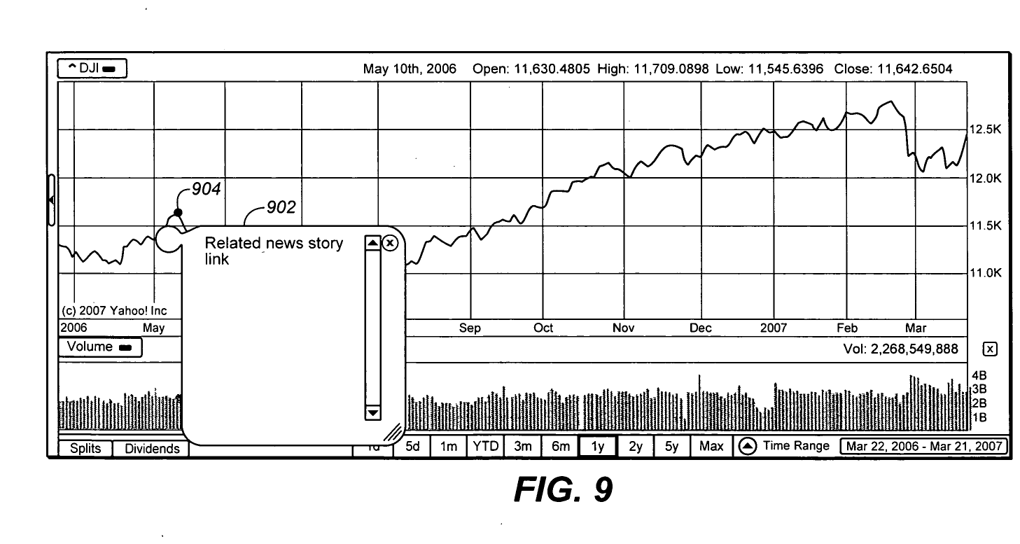

In some embodiments, the user-defined visual indicators displayed on a dynamic chart may be further customized with annotations, as illustrated in FIG. 9. A user may want to include information related to a particular visual indicator. The user can annotate the visual indicator with an annotation, which may include hyperlinks to a news story, hyperlinks to blogs, and personalized messages. An example of an annotation 902 is shown related to visual indicator 904. The annotation 902 includes a link to a related news story. The annotation 902 may appear after a mouseover event on the visual indicator 904.

In other embodiments, the user-defined visual indicators may also be publicly shared with a chosen user or community of users and stored. Users with proper permissions granted by the user who originally defined the conditions may also add annotations to the visual indicators. All user-defined conditions may be stored in persistent storage on the client-side or server-side.

While aspects of the invention, including the above described systems and methods, are described in terms of particular embodiments and illustrative figures, those of ordinary skill in the art will recognize that the invention is not limited to the embodiments or figures described. Those skilled in the art will recognize that the operations of the various embodiments may be implemented using hardware, software, firmware, or combinations thereof, as appropriate. For example, some processes can be carried out using processors or other digital circuitry under the control of software, firmware, or hard-wired logic. (The term “logic” herein refers to fixed hardware, programmable logic, and/or an appropriate combination thereof, as would be recognized by one skilled in the art to carry out the recited functions.) Software and firmware can be stored on computer-readable media. Some other processes can be implemented using analog circuitry, as is well known to one of ordinary skill in the art. Additionally, memory or other storage, as well as communication components, may be employed in embodiments of the invention.

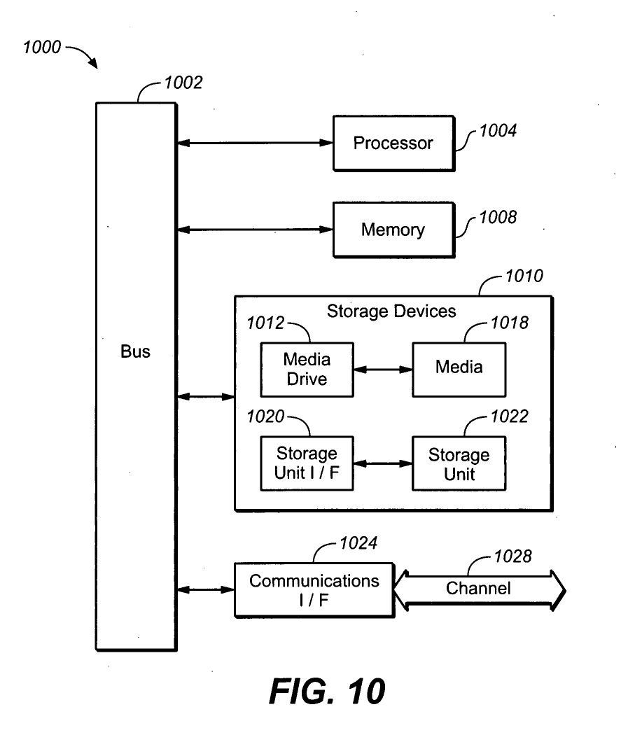

FIG. 10 illustrates an exemplary computing system 1000 that may be employed to implement processing functionality for various aspects of the invention (e.g., as a synchronization server, client device, database, combinations thereof, and so on). Those skilled in the relevant art will also recognize how to implement the invention using other computer systems or architectures. Computing system 1000 may represent, for example, a desktop, mainframe, server, client, or any other type of special or general purpose computing device as may be desirable or appropriate for a given application or environment. Computing system 1000 can include one or more processors, such as a processor 1004. Processor 1004 can be implemented using a general or special purpose processing engine such as, for example, a microprocessor, microcontroller or other control logic. In this example, processor 1004 is connected to a bus 1002 or other communication medium.

Computing system 1000 can also include a main memory 1008, for example random access memory (RAM) or other dynamic memory, for storing information and instructions to be executed by processor 1004. Main memory 508 also may be used for storing temporary variables or other intermediate information during execution of instructions to be executed by processor 1004. Computing system 1000 may likewise include a read only memory (“ROM”) or other static storage device coupled to bus 1002 for storing static information and instructions for processor 1004.

The computing system 1000 may also include information storage mechanism 1010, which may include, for example, a media drive 1012 and a removable storage interface 1020. The media drive 1012 may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media 1018 may include, for example, a hard disk, floppy disk, magnetic tape, optical disk, CD or DVD, or other fixed or removable medium that is read by and written to by media drive 1014. As these examples illustrate, the storage media 1018 may include a computer-readable storage medium having stored therein particular computer software or data.

In alternative embodiments, information storage mechanism 1010 may include other similar instrumentalities for allowing computer programs or other instructions or data to be loaded into computing system 1000. Such instrumentalities may include, for example, a removable storage unit 1022 and an interface 1020, such as a program cartridge and cartridge interface, a removable memory (for example, a flash memory or other removable memory module) and memory slot, and other removable storage units 1022 and interfaces 1020 that allow software and data to be transferred from the removable storage unit 1018 to computing system 1000.

Computing system 1000 can also include a communications interface 1024. Communications interface 1024 can be used to allow software and data to be transferred between computing system 1000 and external devices. Examples of communications interface 1024 can include a modem, a network interface (such as an Ethernet or other NIC card), a communications port (such as for example, a USB port), a PCMCIA slot and card, etc. Software and data transferred via communications interface 1024 are in the form of signals which can be electronic, electromagnetic, optical, or other signals capable of being received by communications interface 1024. These signals are provided to communications interface 1024 via a channel 1028. This channel 1028 may carry signals and may be implemented using a wireless medium, wire or cable, fiber optics, or other communications medium. Some examples of a channel include a phone line, a cellular phone link, an RF link, a network interface, a local or wide area network, and other communications channels.

In this document, the terms “computer program product” and “computer-readable medium” may be used generally to refer to media such as, for example, memory 1008, storage device 1018, storage unit 1022, or signal(s) on channel 1028. These and other forms of computer-readable media may be involved in providing one or more sequences of one or more instructions to processor 1004 for execution. Such instructions, generally referred to as “computer program code” (which may be grouped in the form of computer programs or other groupings), when executed, enable the computing system 1000 to perform features or functions of embodiments of the present invention.

In an embodiment where the elements are implemented using software, the software may be stored in a computer-readable medium and loaded into computing system 1000 using, for example, removable storage drive 1014, drive 1012 or communications interface 1024. The control logic (in this example, software instructions or computer program code), when executed by the processor 1004, causes the processor 1004 to perform the functions of the invention as described herein.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention is limited only by the claims. Additionally, although a feature may appear to be described in connection with particular embodiments, one skilled in the art would recognize that various features of the described embodiments may be combined in accordance with the invention. Moreover, aspects of the invention describe in connection with an embodiment may stand alone as an invention.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather the feature may be equally applicable to other claim categories, as appropriate.

Moreover, it will be appreciated that various modifications and alterations may be made by those skilled in the art without departing from the spirit and scope of the invention. The invention is not to be limited by the foregoing illustrative details, but is to be defined according to the claims.

1. A method for providing a customizable visual indicator on a dynamically generated graphical representation of real-time data, the method comprising:
receiving at least one user-defined condition related to the real-time data, wherein the user-defined condition includes at least one external data condition;
receiving external data related to the at least one external data condition; and
providing at least one visual indicator for display along with a dynamically generated graphical representation of the real-time data in response to satisfaction of the at least one user-defined condition.

2. The method of claim 1, wherein the external data condition relates to a sentiment measure.

3. The method of claim 2, wherein the sentiment measure is based on a community sentiment measure.

4. The method of claim 1, wherein the real-time data is related to stocks.

5. The method of claim 1, wherein the real-time data is related to news.

6. The method of claim 1, further comprising:
receiving an annotation from a user; and
providing the annotation for display along with the at least one visual indicator.

7. The method of claim 1, wherein the at least one visual indicator is stored in a memory.

8. The method of claim 7, wherein the at least one visual indicator is sharable with a plurality of users.

9. The method of claim 8, wherein the at least one visual indicator is modified by another user.

10. The method of claim 1, wherein the at least one visual indicator indicates statistical information relating to the real-time data.

11. The method of claim 1, wherein the user-defined condition is in the form of a Boolean expression.

12. An apparatus for dynamically displaying a visual indicator on a dynamically generated graphical representation for generating an annotated graphical representation of real-time data, the apparatus comprising:
means for receiving at least one user-defined condition related to the real-time data;
means for receiving at least one external data related to the at least one external data condition; and
display means for providing at least one visual indicator for display along wit the a dynamically generated graphical representation of the real-time data in response to satisfaction of the at least one user-defined condition.

13. The apparatus of claim 12, wherein the means for receiving at least one user-defined condition related to the real-time data is a database.

14. The apparatus of claim 12, wherein the means for receiving at least one user-defined condition related to the real-time data is a time series detection engine.

15. The apparatus of claim 12, further comprising a sharable memory for storing the at least one user-defined condition.

16-21. (canceled)

22. The apparatus of claim 12, further comprising:
means for receiving an annotation from a user; and
means for providing the annotation for display along with the at least one visual indicator.

23-24. (canceled)

25. A computer-readable medium comprising instructions for performing a method for providing a customizable visual indicator on a dynamically generated graphical representation of real-time data, the method comprising:
receiving at least one user-defined condition related to the real-time data, wherein the user-defined condition includes at least one external data condition;
receiving external data related to the at least one external data condition; and
providing at least one visual indicator for display along with a dynamically generated graphical representation of the real-time data in response to satisfaction of the at least one user-defined condition.

26. The computer-readable medium instructions of claim 25, wherein the external data condition relates to a sentiment measure.

27. The computer-readable medium instructions of claim 26, wherein the sentiment measure is based on a community sentiment measure.

28-29. (canceled)

30. The computer-readable medium instructions of claim 25, further comprising instructions for:
receiving an annotation from a user; and
providing the annotation for display along with the at least one visual indicator.

31. The computer-readable medium instructions of claim 25, wherein the at least one visual indicator is stored in a memory.

32. The computer-readable medium instructions of claim 31, wherein the at least one visual indicator is sharable with a plurality of users.

33. The computer-readable medium instructions of claim 32, wherein the at least one visual indicator is modified by another user.

34. The computer-readable medium instructions of claim 25, wherein the at least one visual indicator indicates statistical information relating to the real-time data.

35. The computer-readable medium instructions of claim 25, wherein the user-defined condition is in the form of a Boolean expression.
